(19) United States
(12) Patent Application Publication
(10) Pub. No.: US 2006/0059216 A1
(43) Pub. Date: Mar. 16, 2006

(54) Method for square root computation

(75) Inventors: Po-Wei Huang, Hsin Chu (TW); Wen-Kuo Lin, Hsin Chu (TW)

Correspondence Address: TROXELL LAW OFFICE PLLC, SUITE 1404, 5205 LEESBURG PIKE, FALLS CHURCH, VA, 22041, US

(73) Assignee: Silicon Integrated Systems Corp.

(21) Appl. No.: 10/937,266

(22) Filed: Sep. 10, 2004

(51) Int. Cl. G06F 15/00

(52) U.S. Cl. 708/200

(57) ABSTRACT

The present invention describes a method for square root computation, in which a shift-comparison operation is introduced into the computation process so as to obtain correction factors and adjusting factors. The bits of the correction factors are shifted to form estimation terms, and then the adjusting factors are used to correct the estimation terms to obtain the square root. The present invention is advantageous in both high speed for real-time operations and high accuracy.

### BACKGROUND OF THE INVENTION

1. Field of the Invention

The present invention relates to a method for fast and accurate square root computation.

2. Description of the Related Art

Square root computation is often used in numerical calculations, and particularly in geometric calculations, for digital signal processing. Nevertheless, square root computation in a computer is quite complicated, and therefore, for real-time computation, it is usually implemented by a simple structure with less accuracy or by a costly circuit with better approximation.

Referring to FIG. 1, a method for square root computation disclosed in U.S. Pat. No. 6,389,443 is shown. To compute efficiently a square root of a number, a first register of a processor in a computer is first set to an input number X (step S11). A second register is set to another number L, which indicates a number of significant bits of the number X (step S12). Then, the number L is shifted right in the second register by 1 bit to produce another number N (step S13), and the number X is shifted in the first register by N bits to produce a number X1 (step S14). In addition, a third register of the processor is set to 1 and shifted left by N bits to produce a number N1 (step S15). The above numbers N1 and X1 are added to each other (step S16) and shifted right by 1 bit (step S17) to produce an approximation of the square root of the number X (step S18).

However, the above simplified square root algorithm is designed to achieve high operation speed at the cost of accuracy.

### SUMMARY OF THE INVENTION

The present invention provides a method for square root computation, in which a shift-comparison operation is introduced into the computation process so as to obtain correction factors and adjusting factors. The bits of the correction factors are shifted to form estimation terms, and then the adjusting factors are used to correct the estimation terms to obtain the square root.

The method of the present invention comprises the steps of: inputting a number; obtaining one or a plurality of numbers of significant bits of said number; performing a shift-comparison operation to obtain two or more correction factors and one or more adjusting factors; calculating a set of parameters including a first parameter and a second parameter; calculating two or more sets of estimation terms including a first set of estimation terms and a second set of estimation terms by using said set of parameters; and obtaining a square root of said number by determination of the said adjusting factor and calculation with said estimation terms and further through a correction process.

### BRIEF DESCRIPTION OF THE DRAWINGS

Features and advantages of the present invention will be fully understood from the detailed description to follow taken in conjunction with the embodiments as illustrated in the accompanying drawings, which are to be considered in all respects as illustrative and not restrictive, wherein:

FIG. 1 is a flowchart illustrating a conventional method for square root computation;

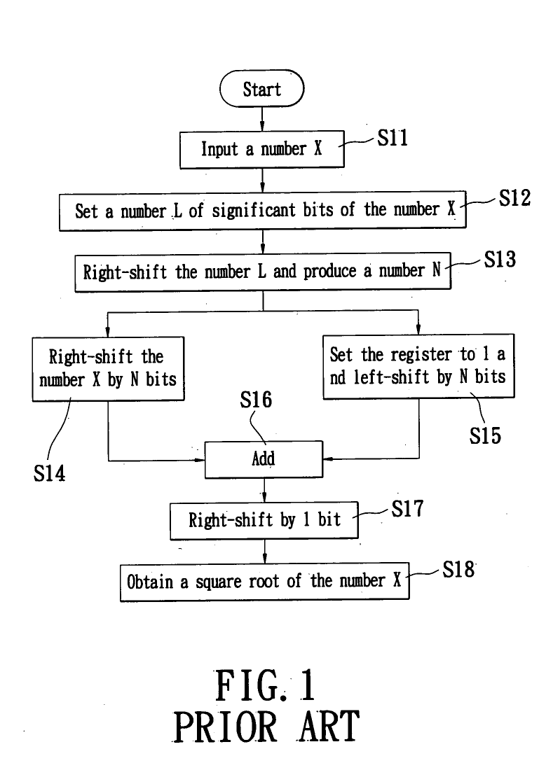

FIG. 2 is a flowchart illustrating a method for square root computation of the present invention;

FIG. 3 is a flowchart illustrating a method for square root computation according to a first embodiment of the present invention; and

FIG. 4 is a flowchart illustrating a method for square root computation according to a second embodiment of the present invention.

### DETAILED DESCRIPTION OF PREFERRED EMBODIMENTS

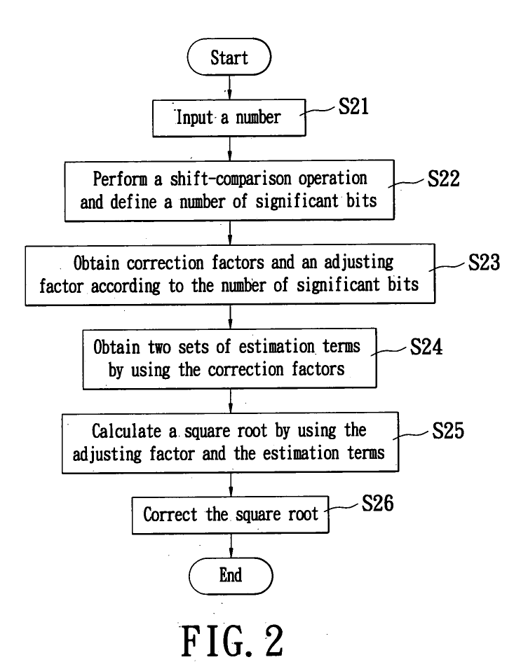

The present invention discloses a method for square root computation with high accuracy and low complexity, which provides fast and real-time square root computation and is particularly suitable for applications in chip design. Operation of the method for square root computation according to the present invention is illustrated in FIG. 2.

Referring to FIG. 2, a number whose square root is to be computed is first input (step S21). Next, a shift-comparison operation is performed and a number of significant bits of the number is defined (step S22). By the shift-comparison operation and by using the number of significant bits, two or more correction factors and one or more adjusting factors are obtained (step S23). Then, two or more sets of estimation terms are calculated based on the above correction factors (step S24). Subsequently, by determination of the adjusting factor and calculation with the estimation terms and further through a correction step, a square root is obtained (step S25). Finally, another correction is performed to obtain the square root to be computed in the invention (step S26).

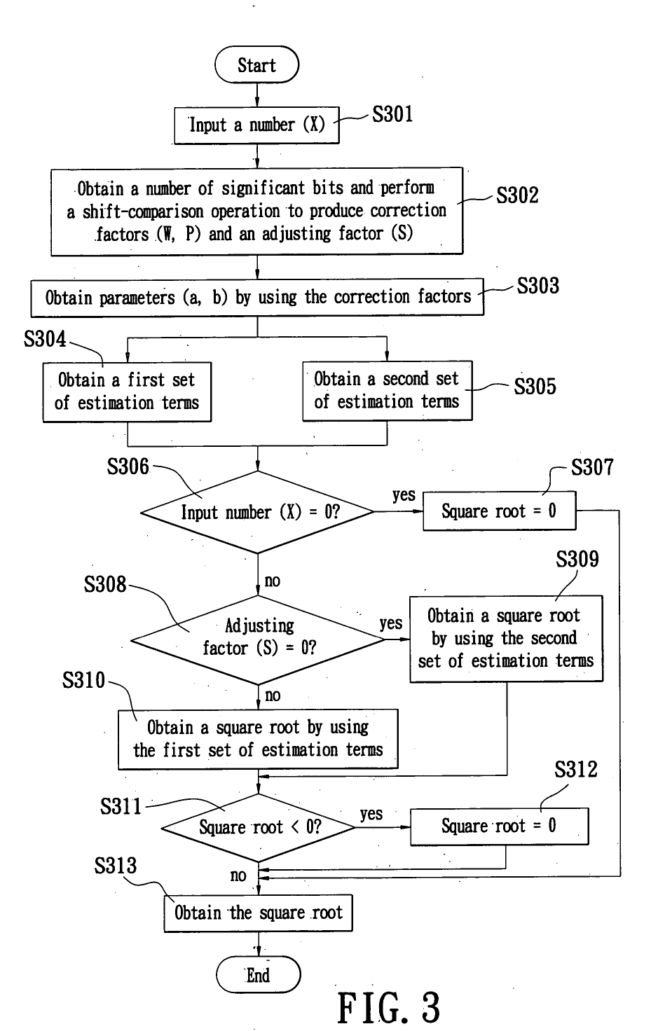

A detailed flowchart of the method for square root computation according to the best embodiment of the invention is illustrated in FIG. 3.

A number X whose square root is to be computed is input (step S301).

First, a number of significant bits of the number X is obtained and then a series of shift-comparison operations is performed to produce two or more correction factors, for example, correction factors W and P in this embodiment, and one or more adjusting factors, for example, one adjusting factor S in this embodiment (step S302). The correction factors W and P and the adjusting factor S are data bits temporarily stored in a register of a memory device. The shift-comparison operation will be explained later with reference to Table 1.

A set of parameters (a, b) is calculated by using the above correction factors (W, P) and adjusting factor (S). The first parameter (a) and second parameter (b) are obtained by shifting the bits of the correction factors W and P in the register (step S303). For example, a=P>>(W+1) and b=((P>>(W+floor(W/2)−1))ˆ2)>>(5+W-floor(W/2)*2), where “>>” indicates a right-shifting operation and “floor(W/2)” indicates an operation of extracting an integer portion of the number W/2. That is, the first parameter (a) equals a number obtained by right-shifting the correction factor P in the register by (W+1) bits, and the second parameter (b) equals a number obtained by right-shifting the correction factor P by (W+floor(W/2)-1) bits, squared, and then shifted right by (5+W-floor(W/2)*2) bits.

Next, two or more sets of estimation terms are calculated by using the parameters (a, b). For example, in step S304, a first set of estimation terms (c0, c1, c2), where c0=1<<W (i.e., bit 1 is shifted left in the register by W bits and W is the correction factor), c1=a (i.e., the estimation term c1 equals the first parameter (a)) and c2=b (i.e., the estimation term c2 equals the second parameter (b)), is obtained.

Meanwhile, in step S305, a second set of estimation terms (d0, d1, d2), where d0=(1<<W)*2ˆ0.5) (i.e., bit 1 is shift left by W bits and multiplied by √2 to obtain the estimation term d0), d1=a/2ˆ0.5) (i.e., the first parameter (a) is divided by √2 to obtain the estimation term d1) and d2=b/2ˆ1.5) (i.e., the second parameter (b) is divided by √2 to obtain the estimation term d2), is obtained. The above formulas for the second set of estimation terms (d0, d1, d2) are further replaced by d0=((1<<W)*181)>>7, d1=(a*181)>>8 and d2=(b*3)>>3, where “<<” indicates a left-shifting operation and “>>” indicates a right-shifting operation, since (2ˆ0.5) approximates to 181>>7, 1/(2ˆ0.5) approximates to 181>>8 and 1/(2ˆ1.5) approximates to 3>>3.

Subsequently, the square root of the input number is calculated with the two sets of estimation terms and the adjusting factor. In order to exclude certain special cases, a plurality of decision boxes are inserted in to the flowchart of the present embodiment to correct the square root obtained in the previous step. These decision boxes include a step of determining whether the input number is 0 (step S306). If the input number X is 0, then the square root of the number is set to 0 (step S307). Therefore, the square root is obtained (step S313) and the process terminates. If the input number X is not 0, then it is further determined whether the adjusting factor S is 0 (step S308). If the adjusting factor is 0, then the square root is obtained by using the second set of estimation terms (d0, d1, d2). For example, the square root is calculated by (d0−d1−d2) in this embodiment (step S309). Then, it is determined whether the thus obtained value is less than 0 in step S311.

If the adjusting factor is not 0, then the square root is obtained by using the first set of estimation terms (c0, c1, c2) (step S310). For example, the square root is calculated by (c0−c1−c2) in this embodiment. Next, it is determined whether the square root is less than 0, which is an unreasonable value and must be avoided (S311). If it is true, then the square root is set to 0 (step S312). If the square root is not less than 0, then this value is the final result of the square root of the input number X (step S313).

The shift-comparison operation mentioned in step S302 is used to produce two correction factors W and P and another adjusting factor S. The shift-comparison operation is shown in Table 1, where the symbol “>>” indicates a right-shifting operation and the symbol “<<” indicates a left-shifting operation.

TABLE 1

| | | | Adjusting Factor |
|---|---|---|---|
| No. | Input Number X | Correction Factors W, P | S |
| 1 | (X >> 16) > 22 | W = 10; P = (1 << 21) − X | S = 0 |
| 2 | (X >> 15) > 22 | W = 10; P = (1 << 20) − X | S = 1 |
| 3 | (X >> 15) > 11 | W = 9; P = (1 << 19) − X | S = 0 |
| 4 | (X >> 16) > 2 | W = 9; P = (1 << 18) − X | S = 1 |
| 5 | (X >> 15) > 2 | W = 8; P = (1 << 17) − X | S = 0 |
| 6 | (X >> 14) > 2 | W = 8; P = (1 << 16) − X | S = 1 |
| 7 | (X >> 13) > 2 | W = 7; P = (1 << 15) − X | S = 0 |
| 8 | (X >> 12) > 2 | W = 7; P = (1 << 14) − X | S = 1 |
| 9 | (X >> 12) > 0 | W = 6; P = (1 << 13) − X | S = 0 |
| 10 | (X >> 10) > 0 | W = 5; P = (1 << 11) − X | S = 0 |
| 11 | (X >> 8) > 0 | W = 4; P = (1 << 9) − X | S = 0 |
| 12 | (X >> 6) > 0 | W = 3; P = (1 << 7) − X | S = 0 |
| 13 | (X >> 4) > 0 | W = 2; P = (1 << 5) − X | S = 0 |
| 14 | Others | W = 0; P = (1 << 1) − X | S = 0 |

As shown in Table 1, the number X whose square root is to be computed consists of one or a plurality of bits. For example, in this embodiment, the number X consists of 22 significant bits. As shown in row No. 1, the number X is shifted right (i.e., all bits of the number X are shifted right) in the register by 16 bits and then compared with 22. If the result is greater than 22, then the correction factor W is set to 10 and the correction factor P is set to a number obtained by left-shifting bit 1 by 21 bits minus the number X, i.e., P=(1<<21)−X, while the adjusting factor S is set to 0. Moreover, as shown in row No. 7, if a number obtained by right shifting the number X by 13 bits is greater than 2, then the correction factor W is set to 7 and the correction factor P is set to a number obtained by left-shifting bit 1 by 15 bits minus the number X, while the adjusting factor S is set to 0. The setting in row No. 14, where the correction factor W is set to 0 and the correction factor P is set to a number obtained by left-shifting bit 1 by 1 bit minus the number X, while the adjusting factor S is set to 0, is applied to those cases that are not listed in rows No. 1 to 13 of Table 1. Table 1 merely illustrates one exemplary embodiment of the shift-comparison operation according to the present invention, and it should not be considered as restrictive.

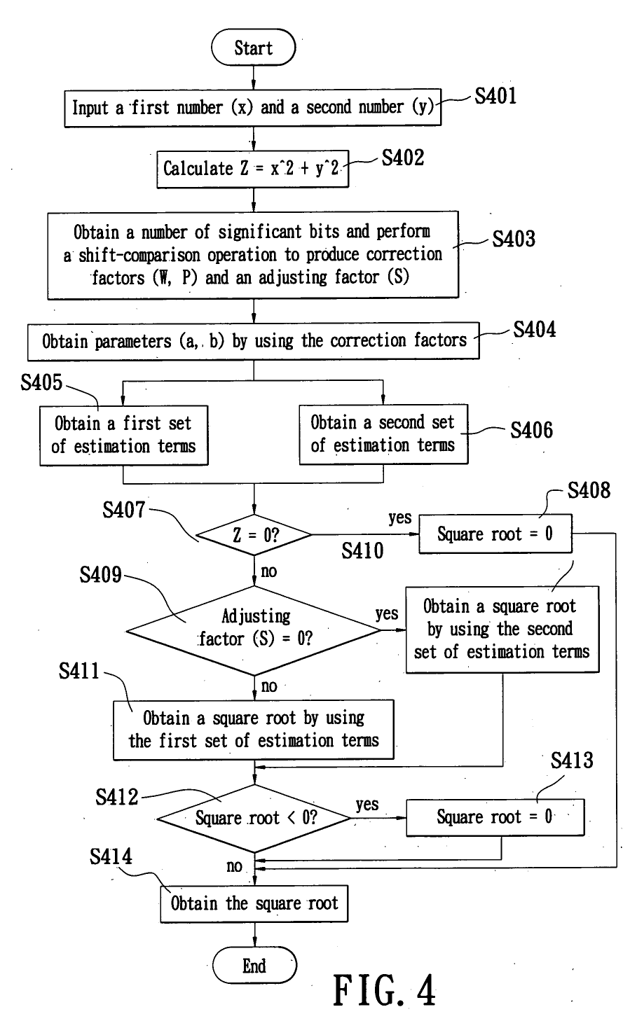

The present invention may be further used to obtain a distance between a point (x, y) and the origin on a coordinate plane, such as a radius of a circle. A flowchart of a second embodiment is shown in FIG. 4.

First, a first number x and a second number y, which may be the same as or different from each other, are input (step S401). Next, a number Z, whose square root is to be computed in this embodiment, is obtained by Z=xˆ2+yˆ2 (step S402). Then a number of significant bits of the number Z is obtained, and a shift-comparison operation is performed to produce correction factors W and P and an adjusting factor S (step S403).

Subsequently, a set of parameters (a, b) is calculated by using the correction factors (W, P) and the adjusting factor (S). The first parameter (a) and the second parameter (b) are calculated by shifting the bits of the correction factors W, P in the register (step S404). Similar to the first embodiment described with reference to FIG. 3, the first parameter (a) may be a number obtained by right-shifting the correction factor P by (W+1) bits, i.e., a=P>>(W+1), whereas the second parameter (b) is calculated by b=((P>>(W+floor(W/2)-1))ˆ2)>>(5+W-floor(W/2)*2), where “floor(W/2)” indicates an operation of extracting an integer portion of the number W/2 and “>>” indicates a right-shifting operation. In other words, the correction factor P is shifted right by (W+floor(W/2)−1) bits, squared, and then shifted right by (5+W-floor(W/2)*2) bits to obtain the second parameter (b).

Next, two or more sets of estimation terms are calculated by using the parameters (a, b). As described in the first embodiment, in step S405, a first set of estimation terms (c0, c1, c2), where c0=1<<W, c1=a and c2=b, is obtained.

Meanwhile, in step S406, a second set of estimation terms (d0, d1, d2), where d0=(1<<W)*(2ˆ0.5), d1=a/(2ˆ0.5) and d2=b/(2ˆ1.5), is obtained. The above formulas for the second set of estimation terms (d0, d1, d2) are further replaced by d0=((1<<W)*181)>>7, d1=(a*181)>>8 and d2=(b*3)>>3, where “<<” indicates a left-shifting operation and “>>” indicates a right-shifting operation, since (2ˆ0.5) approximates to 181>>7, 1/(2ˆ0.5) approximates to 181>>8 and 1/(2ˆ1.5) approximates to 3>>3.

Then, the square root of the number Z is calculated with the two sets of estimation terms and the adjusting factor. In order to exclude certain special cases, a plurality of decision boxes are inserted into the flowchart of the present embodiment to correct the square root obtained in the previous step.

First, it is determined whether the number Z is 0 (step S407). If the number Z is 0, then the square root is directly set to 0 (step S408) and the square root computation process terminates. If the number Z is not 0, then it is further determined whether the adjusting factor S is 0 (step S409). If the adjusting factor is 0, then the square root is obtained by using the second set of estimation terms (d0, d1, d2) (step S410). Then, it is determined whether the thus obtained square root is less than 0 (step S412).

If the adjusting factor is not 0, then the square root is obtained by using the first set of estimation terms (c0, c1, c2) (step S411). Next, it is determined whether the square root is less than 0 (step S412). If the square root is less than 0, which is an unreasonable value, then the square root is set to 0 (step S413) and therefore 0 is the final result of the square root obtained in this invention (step S414). If the square root is not less than 0, then this value is the final result of the square root of the number Z (step S414).

In summary, a shift-comparison operation is introduced into the computation process of the present invention so as to obtain correction factors and an adjusting factor for calculating estimation terms. Thereby, through further correction, a square root can be obtained. The present invention is advantageous in both high speed for real-time operations and high accuracy.

While the present invention has been described with reference to the detailed description and the drawings of the preferred embodiments thereof, it is to be understood that the invention should not be considered as limited thereby. Various modifications and changes could be conceived of by those skilled in the art without departuring from the scope of the present invention, which is indicated by the appended claims.

What is claimed is:

1. A method for square root computation, comprising the steps of:
inputting a number;
performing a shift-comparison operation and defining a number of significant bits of said number;
obtaining two or more correction factors and one or more adjusting factors;
calculating two or more sets of estimation terms by using said correction factors; and
obtaining a square root of said number by determination of the said adjusting factor and calculation with said estimation terms and further through a correction process.

2. The method for square root computation of claim 1, wherein said correction process at least includes determining whether said number is 0 and whether said square root is less than 0.

3. The method for square root computation of claim 1, wherein said adjusting factor is either 0 or 1, respectively corresponding to said square root calculated with said estimation terms.

4. A method for square root computation, comprising the steps of:
inputting a number;
obtaining one or a plurality of numbers of significant bits of said number;
performing a shift-comparison operation to obtain two or more correction factors and one or more adjusting factors;
calculating a set of parameters including a first parameter and a second parameter;
calculating two or more sets of estimation terms including a first set of estimation terms and a second set of estimation terms by using said set of parameters; and
obtaining a square root of said number by determination of the said adjusting factor and calculation with said estimation terms and further through a correction process.

5. The method for square root computation of claim 4, wherein said correction process at least includes determining whether said number is 0 and whether said square root is less than 0.

6. The method for square root computation of claim 4, wherein said adjusting factor is either 0 or 1, respectively corresponding to said square root calculated with said estimation terms.

7. The method for square root computation of claim 4, wherein if said adjusting factor is 0, then said square root is obtained by calculation with the second set of estimation terms, and if said adjusting factor is 1, then said square root is obtained by calculation with the first set of estimation terms.

8. The method for square root computation of claim 4, wherein said parameters are obtained by shifting bits of said correction factors in a register.

9. The method for square root computation of claim 4, wherein said first parameter is P>>(W+1) and said second parameter is ((P>>(W+floor(W/2)−1))ˆ2)>>(5+W-floor(W/2)*2), where P and W are the correction factors, floor( ) indicates an operation of extracting an integer portion of a number, a symbol “>>” indicates a right-shifting operation, and a symbol “<<” indicates a left-shifting operation.

10. The method for square root computation of claim 4, wherein said first set of estimation terms are (1<<W, a, b), where W is the correction factor, a is the first parameter and b is the second parameter.

11. The method for square root computation of claim 4, wherein said second set of estimation terms are ((1<<W)*(2ˆ0.5), a/(2ˆ0.5), b/(2ˆ1.5)), where W is the correction factor, a is the first parameter and b is the second parameter.
